(19) United States
(12) Patent Application Publication
(10) Pub. No.: US 2026/0065437 A1
(43) Pub. Date: Mar. 5, 2026

(54) IMAGE PROCESSING DEVICE AND IMAGE PROCESSING METHOD

(71) Applicant: HAMAMATSU PHOTONICS K.K., Hamamatsu-shi, Shizuoka (JP)

(72) Inventors: Yuya ONISHI, Hamamatsu-shi, Shizuoka (JP); Fumio HASHIMOTO, Hamamatsu-shi, Shizuoka (JP)

(73) Assignee: HAMAMATSU PHOTONICS K.K., Hamamatsu-shi, Shizuoka (JP)

(21) Appl. No.: 19/106,776

(22) PCT Filed: Sep. 25, 2023
(86) PCT No.: PCT/JP2023/034735

§ 371 Date: Feb. 26, 2025

(30) Foreign Application Priority Data
Oct. 5, 2022 (JP) 2022-161053

(51) Int. Cl. G06T 5/70; G06N 3/0464; G06N 3/08

(52) U.S. Cl. CPC G06T 5/70; G06N 3/0464; G06N 3/08; G06T 2207/10081; G06T 2207/10088; G06T 2207/10104; G06T 2207/20084; G06T 2207/20182

(57) ABSTRACT

An image processing apparatus includes a processing unit and a training unit, and performs noise reduction processing on a target image. The processing unit inputs an input image to a CNN, and outputs an output image from the CNN. The training unit uses an evaluation function, and trains the CNN based on a value of the evaluation function. The evaluation function includes an error evaluation term representing an evaluation value related to an error between the output image and the target image, and a regularization term representing an evaluation value related to a difference of pixel values between adjacent pixels in the output image. The image processing apparatus repeatedly performs respective processes of the processing unit and the training unit, and sets the output image after the respective processes are repeatedly performed a certain number of times as an image after the noise reduction processing.

### TECHNICAL FIELD

The present disclosure relates to an apparatus and a method for performing noise reduction processing on a target image.

### BACKGROUND ART

As a technique for performing processing on an image containing noise to reduce the noise, various techniques are known. In the above various noise reduction processing techniques, a technique by using a deep image prior technique using a convolutional neural network, which is a type of a deep neural network, has attracted attention. Hereinafter, the convolutional neural network is referred to as a “CNN”, and the deep image prior technique is referred to as a “DIP technique”.

The DIP technique uses a property of the CNN that meaningful structures in the image are learned faster than random noise (that is, the random noise is less likely to be learned). The noise in the target image can be reduced by using the DIP technique.

For example, a tomographic image of a subject acquired by using a radiation tomography apparatus such as a positron emission tomography (PET) apparatus and a single photon emission computed tomography (SPECT) apparatus contains a lot of noise, and thus, it is necessary to perform the noise reduction processing. In an invention disclosed in Patent Document 1, the tomographic image of the subject reconstructed based on coincidence information collected by using the PET apparatus is used as the target image, and the tomographic image after the noise reduction processing is created by using the DIP technique.

### CITATION LIST

### Patent Literature

Patent Document 1: Japanese Patent Application Laid-Open Publication No. 2020-128882

### Non Patent Literature

Non Patent Document 1: J. Nuyts et al., “A concave prior penalizing relative differences for maximum-a-posteriori reconstruction in emission tomography”, IEEE TNS, Vol. 49, Issue 1, pp. 56-60, 2002
Non Patent Document 2: Hiroyuki Kudo, “Image Reconstruction Methods in Low-Dose CT: Fundamentals of Statistical Image Reconstruction, Iterative Image Reconstruction, and Compressed Sensing”, Medical Imaging Technology, Vol. 32, No. 4, pp. 239-248, 2014
Non Patent Document 3: Antonin Chambolle, “An Algorithm for Total Variation Minimization and Applications”, Journal of Mathematical Imaging and Vision 20, pp. 89-97, 2004

### SUMMARY OF INVENTION

### Technical Problem

The noise reduction processing by using the DIP technique has excellent noise reduction performance, and on the other hand, has a problem of image quality degradation due to overtraining of the CNN. That is, as described above, the DIP technique uses the property of the CNN that the random noise is less likely to be learned, and further, the random noise is also reconstructed as the number of times of training of the CNN increases. As described above, the random noise is also reconstructed due to the overtraining of the CNN, and thus, the image quality is degraded.

An object of the present invention is to provide an image processing apparatus and an image processing method capable of suppressing image quality degradation due to overtraining of a CNN in noise reduction processing by using a DIP technique.

### Solution to Problem

An embodiment of the present invention is an image processing apparatus. The image processing apparatus is an apparatus for performing noise reduction processing on a target image, and includes (1) a processing unit for inputting an input image to a convolutional neural network, and outputting an output image from the convolutional neural network; and (2) a training unit for using an evaluation function including an error evaluation term representing an evaluation value related to an error between the output image and the target image and a regularization term representing an evaluation value related to a difference of pixel values between adjacent pixels in the output image, and training the convolutional neural network based on a value of the evaluation function, and the output image after respective processes of the processing unit and the training unit are repeatedly performed a plurality of times is set as an image after the noise reduction processing.

An embodiment of the present invention is an image processing method. The image processing method is a method for performing noise reduction processing on a target image, and includes (1) a processing step of inputting an input image to a convolutional neural network, and outputting an output image from the convolutional neural network; and (2) a training step of using an evaluation function including an error evaluation term representing an evaluation value related to an error between the output image and the target image and a regularization term representing an evaluation value related to a difference of pixel values between adjacent pixels in the output image, and training the convolutional neural network based on a value of the evaluation function, and the output image after respective processes of the processing step and the training step are repeatedly performed a plurality of times is set as an image after the noise reduction processing.

### Advantageous Effects of Invention

According to the embodiments of the present invention, it is possible to suppress image quality degradation due to overtraining of a CNN in noise reduction processing by using a DIP technique.

### BRIEF DESCRIPTION OF DRAWINGS

FIG. 1 is a diagram illustrating a configuration of an image processing apparatus 1.

FIG. 2 is a diagram illustrating a configuration example of a CNN.

FIG. 3 is a diagram for describing adjacent pixels in an output image.

FIG. 4 includes (a)-(c) diagrams each showing an input image (an MRI image).

FIG. 5 includes (a)-(c) diagrams each showing a phantom image (a correct image).

FIG. 6 includes (a)-(c) diagrams each showing a target image.

FIG. 7 includes (a)-(c) diagrams each showing an output image generated by noise reduction processing by using an image processing method according to a comparative example.

FIG. 8 includes (a)-(c) diagrams each showing an output image generated by noise reduction processing by using an image processing method according to a first example.

FIG. 9 includes (a)-(c) diagrams each showing an output image generated by noise reduction processing by using an image processing method according to a second example.

FIG. 10 includes (a)-(c) diagrams each showing an output image generated by noise reduction processing by using an image processing method according to a third example.

FIG. 11 is a graph showing a relationship between the number of CNN training epochs and a PSNR of the output image for each of the first to third examples and the comparative example.

### DESCRIPTION OF EMBODIMENTS

Hereinafter, embodiments of an image processing apparatus and an image processing method will be described in detail with reference to the accompanying drawings. In the description of the drawings, the same elements will be denoted by the same reference signs, and redundant description will be omitted. The present invention is not limited to these examples, and the Claims, their equivalents, and all the changes within the scope are intended as would fall within the scope of the present invention.

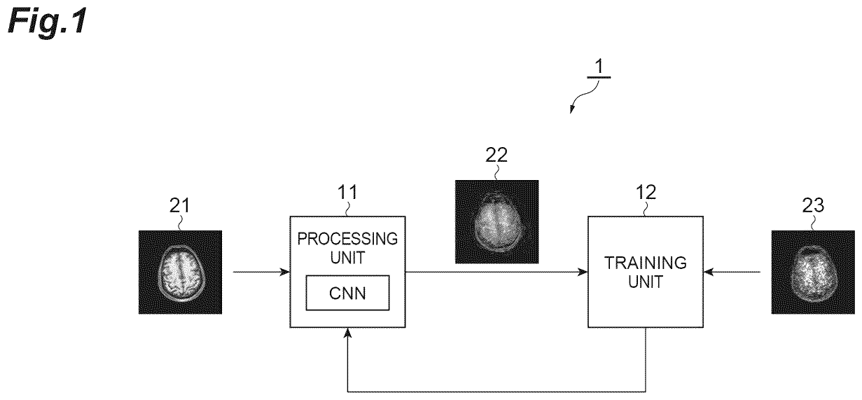

FIG. 1 is a diagram illustrating a configuration of an image processing apparatus 1. The image processing apparatus 1 is an apparatus for performing noise reduction processing on a target image 23.

The image processing apparatus 1 includes a graphics processing unit (GPU) for performing processing by using a convolutional neural network (CNN), an input unit (for example, a keyboard or a mouse) for receiving an input from an operator, a display unit (for example, a liquid crystal display) for displaying an image and the like, and a storage unit for storing a program and data for executing various types of the processing. As the image processing apparatus 1, for example, a computer including a CPU, a RAM, a ROM, a hard disk drive, and the like is used.

The image processing apparatus 1 includes a processing unit 11 and a training unit 12. Further, an image processing method for performing the noise reduction processing on the target image 23 by using the image processing apparatus 1 includes a processing step and a training step. The processing unit 11 inputs an input image 21 to the CNN, and outputs an output image 22 from the CNN (the processing step). The training unit 12 uses an evaluation function based on the output image 22 and the target image 23, and trains the CNN based on a value of the above evaluation function (the training step).

The image processing apparatus 1 repeatedly performs the respective processes of the processing unit 11 and the training unit 12 a plurality of times according to the DIP technique, and sets the output image 22 which is obtained after the respective processes are repeatedly performed a certain number of times as an image after the noise reduction processing.

The target image 23, which is the target of the noise reduction processing, may be set to an arbitrary image. The input image 21 may also be set to an arbitrary image. In this diagram, a PET image is illustrated as an example of the target image 23, and an MRI image is illustrated as an example of the input image 21. The input image 21 may be set to a random noise image.

In the case in which a tomographic image of a subject which is acquired by using a radiation tomography apparatus (for example, a PET apparatus or a SPECT apparatus) is set as the target image 23, the input image 21 may be set to an image representing morphological information of the subject, or may be set to an MRI image, a CT image, or a static PET image of the subject.

The target image 23 may be set to a two-dimensional image, or may be set to a three-dimensional image. In the case in which the target image 23 is set to the two-dimensional image, each of the input image 21 and the output image 22 is also set to the two-dimensional image. In the case in which the target image 23 is set to the three-dimensional image, each of the input image 21 and the output image 22 is also set to the three-dimensional image.

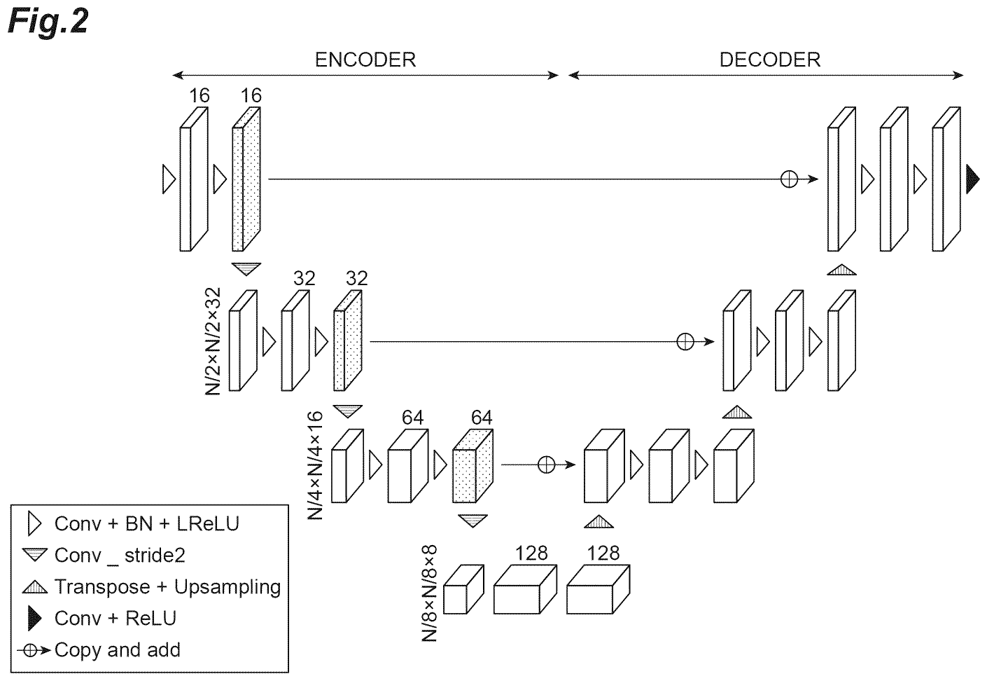

FIG. 2 is a diagram illustrating a configuration example of the CNN. The CNN illustrated in this diagram has a three-dimensional U-net structure including an encoder and a decoder. In this diagram, a size of each of the layers of the CNN is illustrated on the assumption that the number of pixels of the input image 21 which is input to the CNN is set to N×N×64.

Next, the evaluation function which is used by the training unit 12 in the training step will be described. The processing performed by the CNN is set to f, the input image 21 which is input to the CNN is set to g, and a weight coefficient parameter representing a training state of the CNN is set to θ. As the training of the CNN progresses, θ changes. In the case in which the input image g is input to the CNN with the weight coefficient of θ, the output image 22 which is output from the CNN is represented by f_{θ}(g). The target image 23 is set to x₀.

The evaluation function E may be set to an arbitrary function, and for example, a L1 norm, a L2 norm, a negative log likelihood in a Poisson distribution, or the like can be used, and further, in this case, the evaluation function E is represented by a mean squared error (MSE) represented by the following Formula (1). The above evaluation function E includes only an error evaluation term representing an evaluation value related to an error between the output image f_{θ}(g) and the target image x₀.

$$\begin{matrix}[ Formula 1 ] & \\ E = {‖ {f}_{θ} ( g ) - {x}_{0} ‖}^{2} & ( 1 )\end{matrix}$$

The evaluation function E represented by the following Formula (2) includes also a regularization term (a second term on the right side) for suppressing the overtraining of the CNN, in addition to the error evaluation term (a first term on the right side). The regularization term represents an evaluation value related to a difference of pixel values between adjacent pixels in the output image f_{θ}(g). The above regularization term penalizes the difference of the pixel values between the adjacent pixels in the output image. β is a hyperparameter for adjusting the degree of the effect of regularization. The smaller the value of β, the smaller the effect of regularization. The larger the value of β, the larger the effect of regularization (that is, the effect of suppression of the overtraining of the CNN).

$$\begin{matrix}[ Formula 2 ] & \\ E = {‖ {f}_{θ} ( g ) - {x}_{0} ‖}^{2} + β \cdot R ( {f}_{θ} ( g ) ) & ( 2 )\end{matrix}$$

In the case in which the two-dimensional image is used, pixels adjacent to a certain pixel include pixels adjacent to the certain pixel in two directions orthogonal to each other, and further, preferably also include pixels adjacent to the certain pixel in diagonal directions. In the case of the two-dimensional image, the number of pixels adjacent to the certain pixel is 8, excluding pixels located at the edge or the corner of the image.

In the case in which the three-dimensional image is used, pixels adjacent to a certain pixel include pixels adjacent to the certain pixel in three directions orthogonal to each other, and further, preferably also include pixels adjacent to the certain pixel in diagonal directions. In the case of the three-dimensional image, the number of pixels adjacent to the certain pixel is 26, excluding pixels located at the edge or the corner of the image.

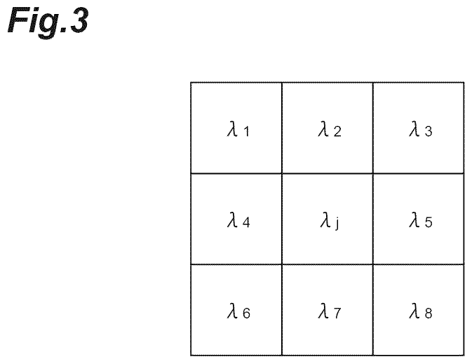

FIG. 3 is a diagram for describing the adjacent pixels in the output image. In this diagram, the output image is illustrated as the two-dimensional image, and 3×3 pixels in the image are illustrated. In this diagram, when a pixel value of the pixel located at the center is set to λⱼ and a pixel value of each of the eight pixels adjacent to the center pixel is set to λₖ (k=1 to 8), the difference of the pixel values between the adjacent pixels with respect to the center pixel is represented by |λⱼ−λₖ|. The regularization term represents the evaluation value related to the difference of the pixel values for all combinations of the adjacent pixels in the output image.

The regularization term is a term for representing the evaluation value related to the difference of the pixel values between the adjacent pixels in the output image, and may be represented by using various formulas. For example, the regularization term is represented by the following Formula (3). In the following Formula (3), Nⱼ represents a set of the pixels k adjacent to the pixel j. γ represents the magnitude of the change of the value of the regularization term with respect to the change of the pixel value λⱼ. The following Formula (3) includes a term of a difference of the pixel values of the adjacent pixels in a numerator, and includes a term of a sum of the pixel values of the adjacent pixels in a denominator, and thus, it represents the evaluation value relating to a relative difference of the pixel values between the adjacent pixels in the output image.

$$\begin{matrix}[ Formula 3 ] & \\ R ( {f}_{θ} ( g ) ) = {\sum }_{j} {\sum }_{k ∈ {N}_{j}} \frac{{( {λ}_{j} - {λ}_{k} )}^{2}}{( {λ}_{j} + {λ}_{k} ) - γ \vert {λ}_{j} - {λ}_{k} \vert} & ( 3 )\end{matrix}$$

In addition, Formula (3) is similar to a formula described in Non Patent Document 1. However, in Non Patent Document 1, the formula similar to Formula (3) is used in the processing of reconstructing the tomographic image of the subject based on the coincidence information collected by using the PET apparatus, and the formula is not used in performing the noise reduction processing for the tomographic image by using the DIP technique.

Further, as the regularization term, for example, Gibbs prior (Non Patent Document 2), total variation (Non Patent Document 3), or the like may also be used. In addition, the above documents also describe a technique for performing the reconstruction processing of the tomographic image of the subject, and do not describe a technique for performing the noise reduction processing for the tomographic image by using the DIP technique.

Next, the result obtained by creating simulation data (the target image) by using a Monte Carlo simulation of a head PET apparatus using a digital brain phantom image, and performing the noise reduction processing for the target image will be described. The phantom image is obtained from Brain Web (https://brainweb.bic.mni.mcgill.ca/brainweb/).

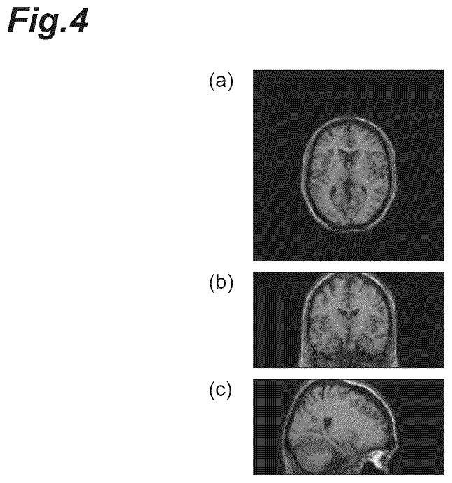

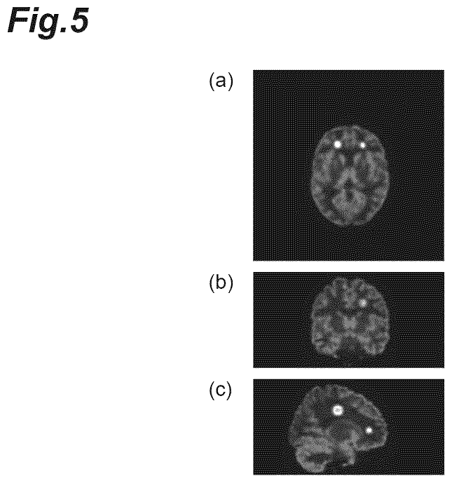

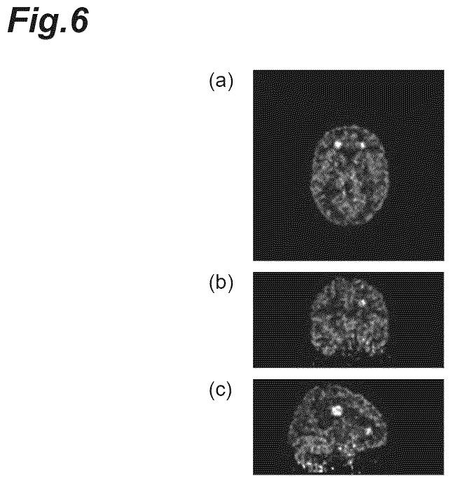

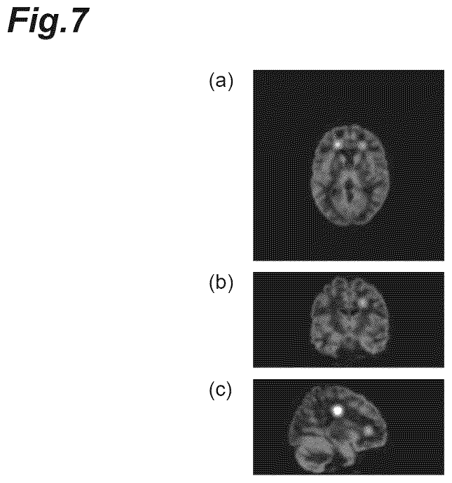

FIG. 4 to FIG. 10 show the images used in the simulation or the images after performing the noise reduction processing. FIG. 4 includes diagrams each showing the input image (the MRI image). FIG. 5 includes diagrams each showing the phantom image (the correct image). FIG. 6 includes diagrams each showing the target image. FIG. 7 includes diagrams each showing the output image generated by performing the noise reduction processing by using the image processing method according to a comparative example.

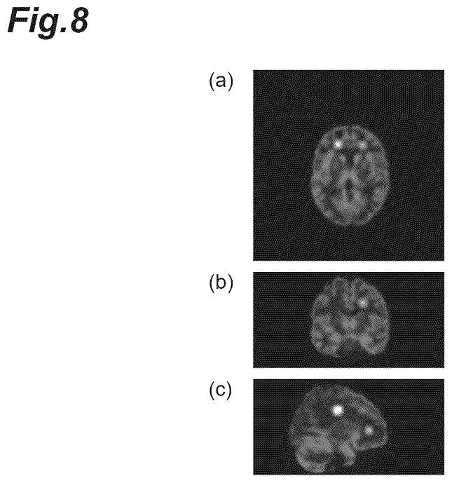

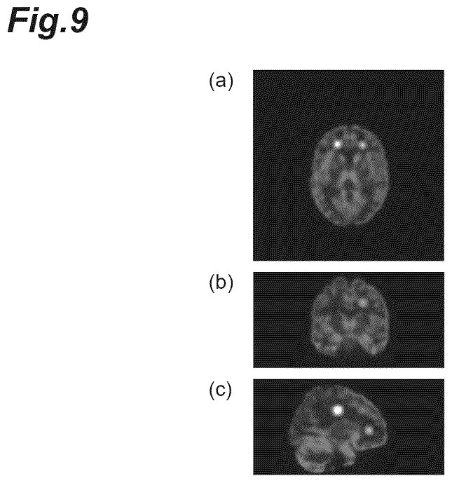

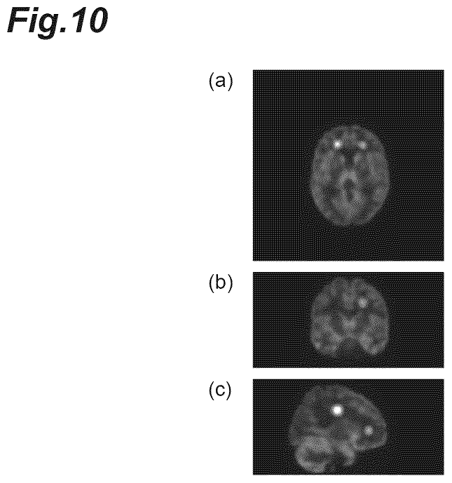

FIG. 8 includes diagrams each showing the output image generated by performing the noise reduction processing by using the image processing method according to a first example. FIG. 9 includes diagrams each showing the output image generated by performing the noise reduction processing by using the image processing method according to a second example. FIG. 10 includes diagrams each showing the output image generated by performing the noise reduction processing by using the image processing method according to a third example. In each of the above diagrams, (a) shows the tomographic image of a transverse section, (b) shows the tomographic image of a coronal section, and (c) shows the tomographic image of a sagittal section.

In the comparative example, the noise reduction processing is performed by using the DIP technique using the evaluation function of the above Formula (1). In each of the first to third examples, the noise reduction processing is performed by using the DIP technique using the evaluation function of the above Formula (2) and Formula (3). In the first example, it is set to β=1×10⁻⁸. In the second example, it is set to β=3×10⁻⁸. In the third example, it is set to β=5×10⁻⁸. In each of the examples, it is set to γ=2.

When FIG. 7 to FIG. 10 are compared, as compared with the comparative example (FIG. 7), in the first to third examples (FIG. 8 to FIG. 10), it is observed that the image quality is improved, and further, it is also observed that the uniformity in a white matter portion is improved.

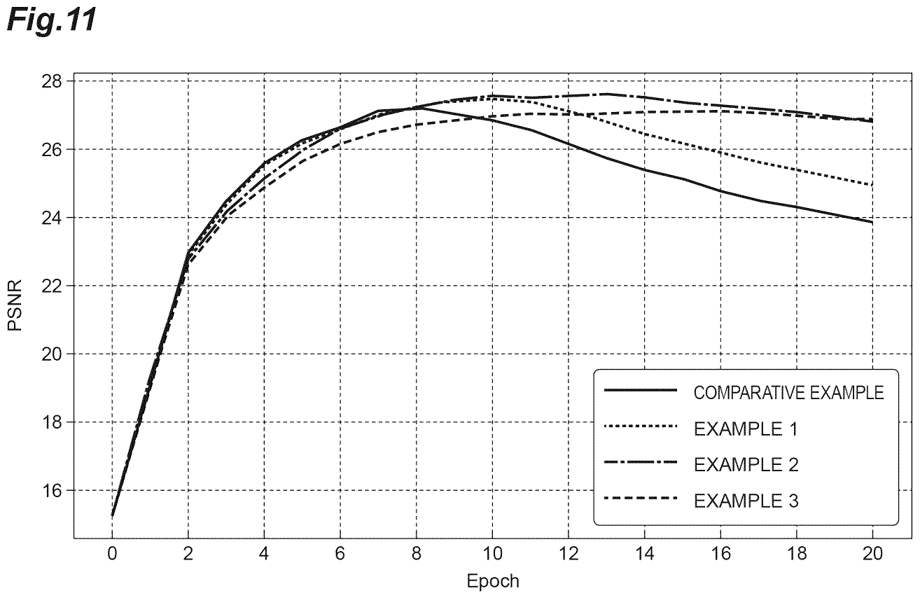

FIG. 11 is a graph showing a relationship between the number of CNN training epochs and a PSNR of the output image for each of the first to third examples and the comparative example. A peak signal to noise ratio (PSNR) is a value representing the quality of the image in decibel (dB), and the higher value means the better image quality. As shown in this diagram, in the comparative example (FIG. 7), the PSNR reaches the maximum value of 27.21 dB when the CNN training is performed 8 times, and the PSNR decreases when the training is further continued thereafter.

In the first example (FIG. 8), the PSNR reaches the maximum value of 27.48 dB when the CNN training is performed 10 times, and the PSNR decreases when the training is further continued thereafter. In the second example (FIG. 9), the PSNR reaches the maximum value of 27.62 dB when the CNN training is performed 13 times, and the PSNR decreases when the training is further continued thereafter. In the third example (FIG. 10), the PSNR reaches the maximum value of 27.10 dB when the CNN training is performed 16 times, and the PSNR decreases when the training is further continued thereafter. In addition, the PSNR of the target image (FIG. 6) is 20.64 dB.

The decrease of the PSNR in the case in which the training of the CNN is continued after the PSNR reaches the maximum value is significant in the comparative example, and further, is reduced in the first to third examples as compared with the comparative example. In the first to third examples, the larger the value of β, the more gradual the decrease of the PSNR after the PSNR reaches the maximum value. Further, the maximum value of the PSNR in the case of each of the first to third examples is larger than the maximum value of the PSNR in the case of the comparative example.

As described above, in the noise reduction processing by using the DIP technique, it is confirmed that the image quality degradation due to the overtraining of the CNN can be suppressed by training the CNN using the evaluation function including the regularization term representing the evaluation value related to the difference of the pixel values between the adjacent pixels in the output image from the CNN, and further, it is also confirmed that the noise reduction performance can be improved.

The image processing apparatus and the image processing method are not limited to the embodiments and configuration examples described above, and various modifications are possible.

The image processing apparatus of a first aspect according to the above embodiment is an apparatus for performing noise reduction processing on a target image, and includes (1) a processing unit for inputting an input image to a convolutional neural network, and outputting an output image from the convolutional neural network; and (2) a training unit for using an evaluation function including an error evaluation term representing an evaluation value related to an error between the output image and the target image and a regularization term representing an evaluation value related to a difference of pixel values between adjacent pixels in the output image, and training the convolutional neural network based on a value of the evaluation function, and the output image after respective processes of the processing unit and the training unit are repeatedly performed a plurality of times is set as an image after the noise reduction processing.

In the image processing apparatus of a second aspect, in the configuration of the first aspect, the target image may be set to a tomographic image of a subject created based on coincidence information collected by using a radiation tomography apparatus.

In the image processing apparatus of a third aspect, in the configuration of the second aspect, the processing unit may input an image representing morphological information of the subject to the convolutional neural network as the input image.

In the image processing apparatus of a fourth aspect, in the configuration of the second aspect, the processing unit may input an MRI image of the subject to the convolutional neural network as the input image.

In the image processing apparatus of a fifth aspect, in the configuration of the second aspect, the processing unit may input a CT image of the subject to the convolutional neural network as the input image.

In the image processing apparatus of a sixth aspect, in the configuration of the second aspect, the processing unit may input a static PET image of the subject to the convolutional neural network as the input image.

In the image processing apparatus of a seventh aspect, in the configuration of the first or second aspect, the processing unit may input a random noise image to the convolutional neural network as the input image.

The image processing method of a first aspect according to the above embodiment is a method for performing noise reduction processing on a target image, and includes (1) a processing step of inputting an input image to a convolutional neural network, and outputting an output image from the convolutional neural network; and (2) a training step of using an evaluation function including an error evaluation term representing an evaluation value related to an error between the output image and the target image and a regularization term representing an evaluation value related to a difference of pixel values between adjacent pixels in the output image, and training the convolutional neural network based on a value of the evaluation function, and the output image after respective processes of the processing step and the training step are repeatedly performed a plurality of times is set as an image after the noise reduction processing.

In the image processing method of a second aspect, in the configuration of the first aspect, the target image may be set to a tomographic image of a subject created based on coincidence information collected by using a radiation tomography apparatus.

In the image processing method of a third aspect, in the configuration of the second aspect, in the processing step, an image representing morphological information of the subject may be input to the convolutional neural network as the input image.

In the image processing method of a fourth aspect, in the configuration of the second aspect, in the processing step, an MRI image of the subject may be input to the convolutional neural network as the input image.

In the image processing method of a fifth aspect, in the configuration of the second aspect, in the processing step, a CT image of the subject may be input to the convolutional neural network as the input image.

In the image processing method of a sixth aspect, in the configuration of the second aspect, in the processing step, a static PET image of the subject may be input to the convolutional neural network as the input image.

In the image processing method of a seventh aspect, in the configuration of the first or second aspect, in the processing step, a random noise image may be input to the convolutional neural network as the input image.

### INDUSTRIAL APPLICABILITY

The present invention can be used as an image processing apparatus and an image processing method capable of suppressing image quality degradation due to overtraining of a CNN in noise reduction processing by using a DIP technique.

### REFERENCE SIGNS LIST

1—image processing apparatus, 11—processing unit, 12—training unit, 21—input image, 22—output image, 23—target image.

1. An image processing apparatus for performing noise reduction processing on a target image, the apparatus comprising:
a processing unit configured to input an input image to a convolutional neural network, and output an output image from the convolutional neural network; and
a training unit configured to use an evaluation function including an error evaluation term representing an evaluation value related to an error between the output image and the target image and a regularization term representing an evaluation value related to a difference of pixel values between adjacent pixels in the output image, and train the convolutional neural network based on a value of the evaluation function, wherein
the output image after respective processes of the processing unit and the training unit are repeatedly performed a plurality of times is set as an image after the noise reduction processing.

2. The image processing apparatus according to claim 1, wherein the target image is a tomographic image of a subject created based on coincidence information collected by using a radiation tomography apparatus.

3. The image processing apparatus according to claim 2, wherein the processing unit is configured to input an image representing morphological information of the subject to the convolutional neural network as the input image.

4. The image processing apparatus according to claim 2, wherein the processing unit is configured to input an MRI image of the subject to the convolutional neural network as the input image.

5. The image processing apparatus according to claim 2, wherein the processing unit is configured to input a CT image of the subject to the convolutional neural network as the input image.

6. The image processing apparatus according to claim 2, wherein the processing unit is configured to input a static PET image of the subject to the convolutional neural network as the input image.

7. The image processing apparatus according to claim 1, wherein the processing unit is configured to input a random noise image to the convolutional neural network as the input image.

8. An image processing method for performing noise reduction processing on a target image, the method comprising:
a processing step of inputting an input image to a convolutional neural network, and outputting an output image from the convolutional neural network; and
a training step of using an evaluation function including an error evaluation term representing an evaluation value related to an error between the output image and the target image and a regularization term representing an evaluation value related to a difference of pixel values between adjacent pixels in the output image, and training the convolutional neural network based on a value of the evaluation function, wherein
the output image after respective processes of the processing step and the training step are repeatedly performed a plurality of times is set as an image after the noise reduction processing.

9. The image processing method according to claim 8, wherein the target image is a tomographic image of a subject created based on coincidence information collected by using a radiation tomography apparatus.

10. The image processing method according to claim 9, wherein in the processing step, an image representing morphological information of the subject is input to the convolutional neural network as the input image.

11. The image processing method according to claim 9, wherein in the processing step, an MRI image of the subject is input to the convolutional neural network as the input image.

12. The image processing method according to claim 9, wherein in the processing step, a CT image of the subject is input to the convolutional neural network as the input image.

13. The image processing method according to claim 9, wherein in the processing step, a static PET image of the subject is input to the convolutional neural network as the input image.

14. The image processing method according to claim 8, wherein in the processing step, a random noise image is input to the convolutional neural network as the input image.
